(19) United States
(12) Patent Application Publication
(10) Pub. No.: US 2015/0301526 A1
(43) Pub. Date: Oct. 22, 2015

(54) Smart Keyless Entry And Vehicle Control System

(71) Applicant: Danny Tjandra, Houston, TX (US)

(72) Inventor: Danny Tjandra, Houston, TX (US)

(21) Appl. No.: 14/254,772

(22) Filed: Apr. 16, 2014

(51) Int. Cl. G05D 1/00; B60R 25/104; B60R 25/102

(52) U.S. Cl. CPC G05D 1/0011; B60R 25/102; B60R 25/104; B60R 2025/1016

(57) ABSTRACT

Two key technologies that gain popularities these days are wireless-connectivity and smart devices. Exploiting the benefit of these two technologies can allow us to have the next generation of vehicle-mounted control system that allows remote operation, protection, and/or monitoring. It allows the vehicle owner to have a true security system, rather than just intruder-deterrent system. It also allows different programmability that enhance the user's convenience, by allowing the vehicle to react in a certain way, according to its environment.

### SUMMARY OF INVENTION

Briefly, this invention offers a new generation of vehicle-mounted control system apparatus that can be controlled and/or monitored by the user, via multitude wireless connectivity. It allows the user to use their smart devices, such as tablet, computer, cellular-phone, etc; to secure, operate, and monitor the vehicle.

This invention uses data connection, via the de-facto GSM/CDMA-modem and/or Bluetooth, to perform remote controlling and/or monitoring. It also allows some level of closed-loop automatic operation and/or based on scheduling.

The apparatus also continuously performs periodic self test to the sensor and the output circuitry to warranty its performance. The remote user will be informed, via warning massages, when this level performance can't be guaranteed.

### DESCRIPTIONS

### Description of Drawings

The drawings, shown it the previous section, are provided to better illustrate the invention:

FIG. 1-FIG. 4 are simplified block diagrams, showings the multitude of how the users can interact to the vehicle remotely.

FIG. 5 shows an example of the different components that can be included in the vehicle mounted control unit. Each of these components can be implemented as hardware and/or firmware.

FIG. 6 shows the modular output module that can be supported by this invention. It shows the self diagnostic component that performs the safety function by periodically verify the performance of the circuitry, sensors, and actuators.

### BACKGROUND OF INVENTION

1. Field of Invention

The present invention relates to a safety method, system, and apparatus that can controls the vehicle automatically; and/or remotely by using smart device.

2. Description of Prior Art

A little portion of this invention is the next generation of keyless remote entry and/or security system that is normally found most vehicles. But this invention is meant to be aware of a lot more environment variables. It also has several different options of automatic operation and ways to inform the remote user about any of those environment variables.

This invention is also meant to have higher degree of safety, which has not been offered in any of the currently available system. All the keyless remote entries and/or security systems in the market today are trust-based, in the way that it is blindly trusted to be able to function when the time come. This invention owns a self diagnostic hardware and software that periodically verifies that the output circuitry and the sensors are in good condition, and any action request will be executed without fail.

This invention also offers continuous monitoring function, via multitude communication paths. The user can request the status of the vehicle anytime. The vehicle also possesses the ability to inform the user when certain event/malfunction occurs.

### DESCRIPTION OF THE PREFERRED EMBODIMENT

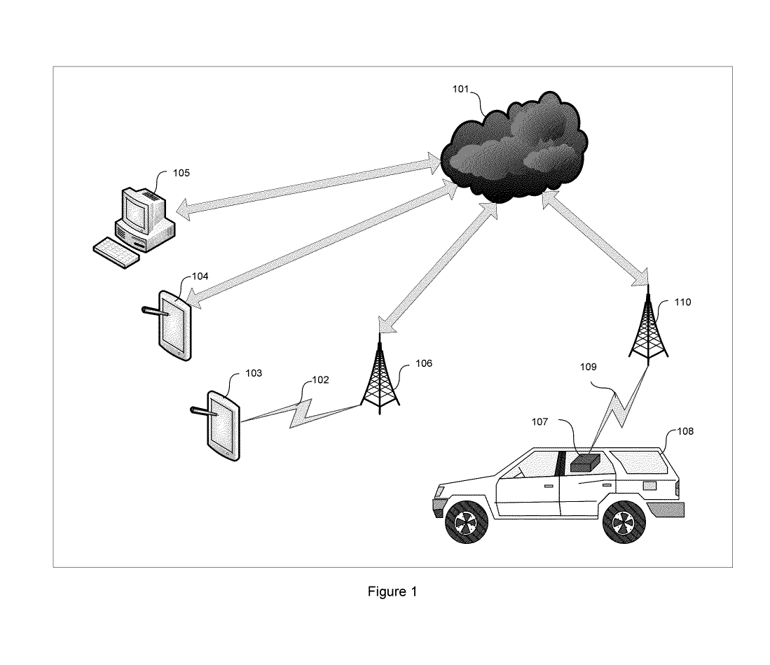

FIG. 1 depicts the multitude embodiment of point-to-point communication to the vehicle based on the internet connection 101. The control system 107, mounted inside of the vehicle 108, is connected to the internet 101 by using GSM/CDMA cellular data channel 109; that is wirelessly connected to the cellular providers' antenna 110. The remote controlling unit is connected to the internet in several different ways.
Any web-browser that runs in the computer 105; that is connected to the internet 101, can access the web-server resided in vehicle-mounted controller 107.
The remote devices 104 represent smart-devices, which have Wi-Fi transceiver, which has direct access to the internet, and runs native software to communicate to the controller 107.
The remote controlling device 103, is running a native software, similar to 104. But it uses cellular data connection 102, either GSM or CDMA, to access the internet, via the provider's antenna 106.

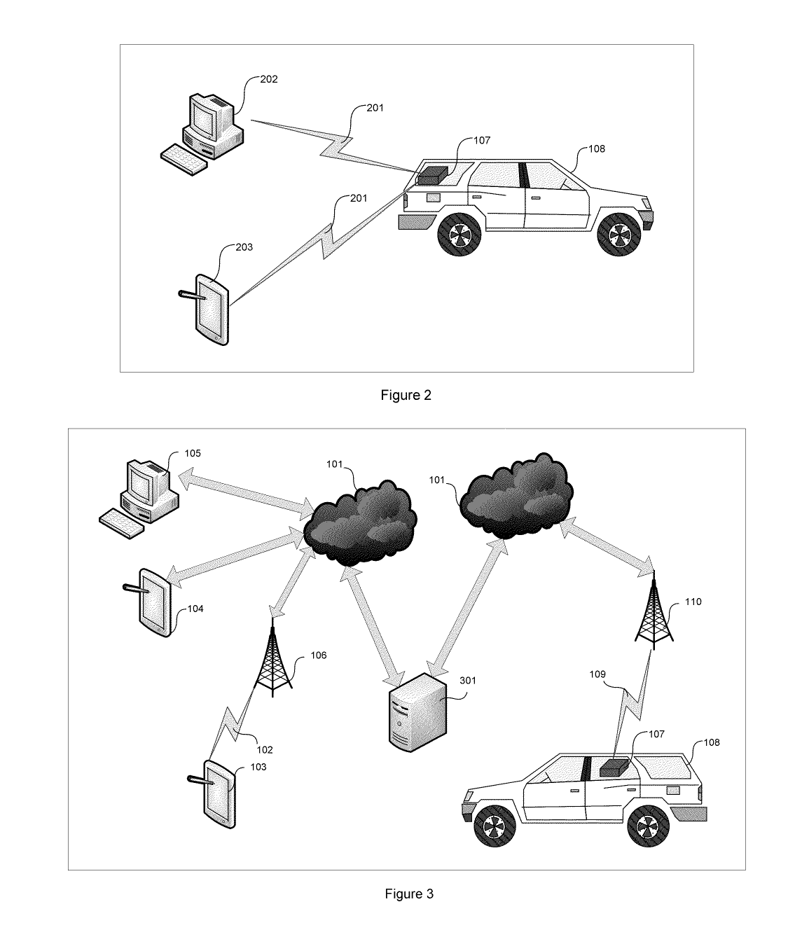

FIG. 2 represent the embodiment of short-distance and point-to-point connection by using Bluetooth connection. In this mode, the pc devices 202 or smart devices 203 have to run special software, with proper encryption system, to control the vehicle-mounted unit 107. In this mode, the device 202 and 203 acts “almost similar” to the regular OOK based remote-control, which is normally offered by today's standard keyless entry system, except the specially written software can offer a multitude of automation such as:
Personalized setting, based on the Bluetooth MAC-Address
Scheduling, such automatically performs engine warm up every morning during the weekdays.
Automated door locking and unlocking when certain MAC address is detected
Automatically turn on the engine and the refrigeration (AC) system, when it the temperature inside the vehicle is hot.
Etc.

FIG. 3 is a block diagram that uses an intermediary hosted server to communicate between the remote controlling unit and the vehicle-mounted controller. This mode can be disabled or enabled by the user, for each feature of offered by the vehicle-mounted controller 107. This mode of operation is very useful when any of the point-to-point communication isn't reliable enough. When enabled, the vehicle-mounted controller will periodically synchronized itself to the hosted web-server 301, which includes updating it status and pulling any delayed command requested by the user. The user of device 105, 104, or 103, at future time, can use its web-browser to check:
The last reported status of the vehicle 107
If the last command has been sent and executed properly
Playback the history/log file
Sends command that will be executed the next time when the vehicle-mounted controller 107 synchronized itself to the hosted web-server 301.

FIG. 4 shows the block diagram of the embodiment, when an encoded text message is used to communicate between sms-enabled device and the vehicle-mounted controller 107. It also has and added convenience, in which the user of the remote controller 103 doesn't have to continuously checks the status of the vehicle-mounted controller 107. Instead, the message will automatically be delivered to the remote controller 103, as it is becomes available and accessible. Because of this feature, this method will also be used to deliver critical warning message, such as failure, intrusion, and/or malfunction.

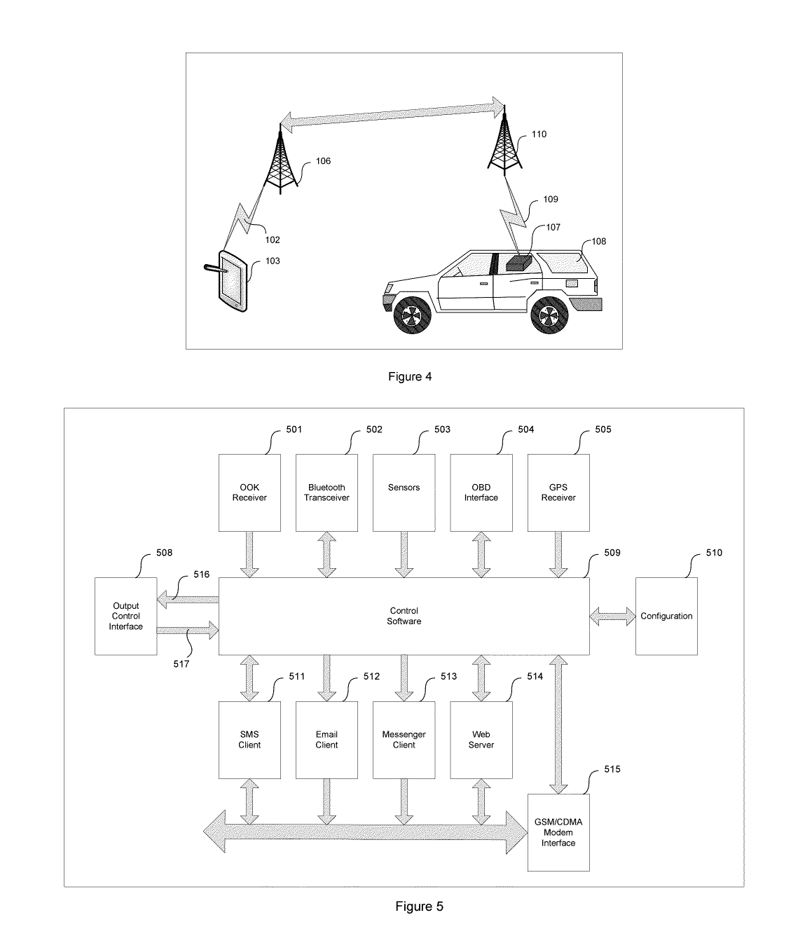

FIG. 5 shows the block diagram of each components/module that can be used to achieve a smart vehicle-mounted controlled module. The Control software 509, responsible it tie up all of the process together. The OOK receiver 501 is provided only to bring up the control software in to a special mode in order to allow the Bluetooth 502 to be paired, when the other method has not been properly configured yet. The Bluetooth transceiver unit 502 is a part of the remote controlling method, as it has been discussed earlier. The sensors Interfaces 503 can be modular, depending on the level of automation that want to be achieved. Some of the sensors that will be implemented are:
Shock sensors
Temperature & humidity sensors
Magnetic sensors
Gyroscope
Accelerometer
Switches (mechanical or reed), such as door sensors
Glass breakage sensors
Water intrusion sensors
Pressure sensor
Proximity sensor
Light curtain
CCD Camera
Audio input

The OBD interface is used to monitor the vehicle parameter, including but not limited to:
Speed monitoring and logging
Checking the presence of engine trouble code
Remote diagnostic & assistance
Etc

GPS Receiver 505 can be used to monitor the vehicle parameter, including but not limited to:
Vehicle tracking and logging
Location based, automatic configuration
Remote assistance
Assistance to find parking spot
Etc.

The configuration unit 510 is a persistence/non-volatile area, in which all of the parameter that can be controlled and monitored. It can hold multiple configurations, and can automatically select the appropriate active configuration, based its environment.

The SMS Client 511, Email Client 512, Messenger Client 513, Web Server Client, and the modem interface 515; are a part of the communication interface as it was discussed in previous paragraphs. The modem interface 515 communicates to the actual off-the-shelf modem via industry standard buses such as USB, Serial (UART), etc.

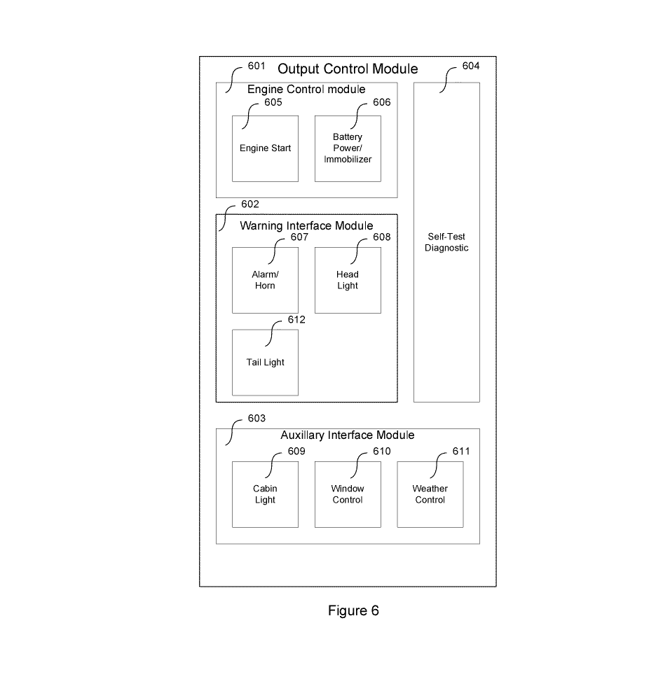

FIG. 6 is the detailed embodiment of typical output control interface 508, shown in FIG. 5. This is a modular interface, in which the user can choose what level of automation desired. The interfaces are categorized as Engine Control Module 601, Warning Module 602, and Auxiliary module 603. Non-critical modules, such as cabin light might not have self diagnostic, or have the self diagnostic turned off by default.

The engine control Module 605, consist minimally required interface that will not be a part of the selective modular option. This includes Engine starting module 605 and Battery power/immobilizer interface 606.

The warning Interface module 602 includes all the modules that can be used to deter intruder or warn people about the intrusion. Alarm/Horn interface 607 can be used as audio confirmation when a command is executed, but it can also be used to deter intruder when it detect possible intrusion attempt. Head Light Interface 608 can also be used as visual confirmation. It can also be used to help user in the poorly lighted parking location, to locate the car and/or deter hidden intruder. Either the head light module 608 or tail light module 612 can be use to seek help silently by emitting certain flashing pattern.

The auxiliary controllers 603 consist of modules that are absolutely optional, depending on the level of automation wanted. Cabin Light module 609 can be use to automatically light up the cabin after the engine has been turned off or after the door has been opened. The window control module can be used to automatically close the window a little bit when water intrusion sensor (in the sensors module 503) detect the present of water, in the event of rain. The weather control module can be used to keep certain comfort level by automatically control the engine (via battery power module 606 and engine starter 605) and the refrigeration system, when the temperature sensor (in the sensors module 503) reach a certain pre-defined limit.

What is claimed are:

1. The vehicle-mounted that can be used to control and monitor the vehicle via smart devices

2. The method of claim 1, that allows the uses PC and/or smart devices to remotely control the vehicle mounted controller.

3. The method of claim 1, that allows the uses PC and/or smart devices to remotely programs the interaction between sensors and output module

4. The method of claim 1, that allows the uses PC and/or smart devices to remotely perform firmware and software upgrade

5. The method of claim 1, that uses specially natively written code for the smart devices

6. The method of claim 1, that allows remote vehicle diagnostic and/or assistance when OBD interface module is installed.

7. The ability to control and monitor the vehicle mounted controller device from remote location by using multitude communication method

8. A method of claim 7, that make use of the shelf GSM/CDMA modem to accomplish cellular data communication in every part of the world, regardless the frequency band.

9. A method of claims 7 and 8, that use point-to point communication with specially written software with encryption system.

10. A method of claims 7 and 8, that uses built in web server to enable access from any device with web-browser.

11. A method of claims 7 and 8, that uses hosted web-page to perform delayed synchronization, which can be used when reliable point-to-point communication can't be obtained.

12. A method of claims 7 and 8, that uses encrypted SMS messages to perform remote operation via encrypted text message.

13. A method of claim 7, that uses encrypted Bluetooth communication accompanied additional by data-encryption to accomplish short-distance secure communication.

14. The unique method of asking assistance from, and inform to, other people about an intrusion, or malfunction.

15. The method of claim 14, that silently uses flashing head light to indicate intrusion.

16. The method of claim 14, that silently uses flashing tail light to indicate intrusion.

17. The method of claim 14, in which the vehicle mounted unit automatically sends Text messages when malfunction and/or intrusion and detected.

18. The method of claim 14, in which the vehicle mounted unit automatically sends email to selected email address messages, when malfunction and/or intrusion are detected.

19. The method of claim 14, in which the vehicle mounted unit automatically sends message(s) via message client (such as tweeter, AOL, MSN, etc) messages when malfunction and/or intrusion are detected.

20. The interaction and automation offered by the software in the vehicle mounted controller by itself, or having interaction with the remote controller.

21. The method of claim 20, that use scheduler to automatically warms up the engine. The scheduler can reside in the remote controller, the hosted web-server, and or embedded in the vehicle-mounted unit itself.

22. The methods of claim 20, that make use the water intrusion sensor to automatically close the window.

23. The method of claim 20, that uses temperature sensor to keep certain comfort level. This method can also be connected to the scheduler and/or the location detected by the GPS.

24. The safety system that performs automatic & periodic diagnostic hardware and software to warranty the performance of the vehicle mounted unit.

25. The method of claim 24, that uses special software and hardware to automatically try to partially operates the actuator and detects the result of the operation

26. The method of claim 24, that uses closed-loop system, in which sensor(s) is/are used to make sure that certain effect is obtain when certain operation is performed. For example, the temperature reading versus the activity of the weather control output module.

27. The method of claim 24, which compares the result of sensor reading in relation to other sensor. For example GPS changes versus accelerometer and/or magnetic sensors.

28. The method of claim 24, in which warning messages is sent via method of claimed 14, when the self diagnostic modules has detected error(s) and performance can't be guaranteed.
